(19) United States
(12) Patent Application Publication
(10) Pub. No.: US 2026/0285075 A1
(43) Pub. Date: Sep. 24, 2026

(54) SECURITY FEATURE

(71) Applicant: CCL Secure Pty Ltd, Craigieburn (AU)

(72) Inventor: Justin Lawson, Craigieburn (AU)

(21) Appl. No.: 19/474,700

(22) PCT Filed: Apr. 15, 2024
(86) PCT No.: PCT/AU2024/050355

§ 371 Date: Oct. 11, 2025

(30) Foreign Application Priority Data
Apr. 13, 2023 (AU) 2023901086

(51) Int. Cl. B41M 3/14; B42D 25/351; B42D 25/373; B42D 25/378

(52) U.S. Cl. CPC B41M 3/144; B42D 25/351; B42D 25/373; B42D 25/378; B41M 2205/38

(57) ABSTRACT

A security feature for a security document, the security feature comprising one or more photoluminescent ink layers, each including a composition capable of emitting visible light when irradiated with a specified electromagnetic wavelength range, wherein the one or more photoluminescent ink layers are at least partially printed in a window region of the security document.

### TECHNICAL FIELD

The present disclosure broadly relates to security features provided on a substrate of a security document, comprising a number of printed layers, and methods of forming such security features.

### BACKGROUND OF INVENTION

It is important that security documents such as banknotes, credit cards, ID documents (including passports), land title, share and educational certificates, packaging materials for high-value goods, security labels and security cards are difficult to replicate by counterfeiters and be provided with security features allowing their authentication.

Design elements that photo luminesce, particularly fluoresce, in the visible light spectrum when exposed to a specific electromagnetic wavelength range, such as ultraviolet (UV) illumination, are commonly used as level 2 security features on paper-based banknotes (i.e. those banknotes which are produced using predominantly fibrous paper based materials). Such elements are, typically, transparent or white when viewed under ordinary lighting conditions (i.e. invisible either due to transparency or background). However, when viewed under UV light, the design elements glow brightly and show a visible colour to reveal themselves. Existing UV design elements are typically incorporated into banknote serial numbers, banknote denomination, issuing bank, and the like, which occupy a relatively small area of the banknotes, thus leaving the remaining surface area of the banknotes for other security features or design elements. In addition, these UV design elements are usually authenticated from a single side of the banknotes, typically from the same side on which the UV elements are applied. If authentication is attempted from an opposite side of the banknotes, the visible colours generated may be substantially blocked or absorbed by the opaque substrates of the banknotes.

Polymer banknotes are another form of physical currency. A special polymer substrate made of biaxially oriented polypropylene is used to produce the polymer banknotes. The polymer banknotes typically comprise a transparent base film. A plurality of opacifying layers are sequentially printed onto the transparent base film on both sides, to create a suitable printing surface and a substantially uniform coloured background (e.g. white), before other security features or design layers are introduced.

It is desirable to provide a UV security feature to polymer banknotes, or to at least provide a useful or an alternative choice.

Any reference herein to a patent document or other matter which is given as prior art is not to be taken as an admission that the document or matter was known or that the information it contains was part of the common general knowledge as at the priority date of any of the claims.

### SUMMARY OF INVENTION

In a first aspect, the present disclosure provides a security feature for a security document, the security feature comprising:
one or more photoluminescent ink layers, each including a composition capable of emitting visible light when irradiated with a specified electromagnetic wavelength range, wherein the one or more photoluminescent ink layers are at least partially printed in a window region of the security document.

In some embodiments, the one or more photoluminescent ink layers are fluorescing ink layers, preferably, the specified electromagnetic wavelength range is Ultra Violet (UV). In other embodiments the one or more photoluminescent ink layers are phosphorescing ink layers.

In some embodiments, the security feature includes three photoluminescent ink layers, wherein each photoluminescent ink layer includes a fluorescent composition arranged to emit a coloured visible light when irradiated with UV.

In some embodiments, the three photoluminescent ink layers are each arranged to emit a primary visible colour when irradiated with UV.

In some embodiments, the three photoluminescent ink layers are arranged to emit a red, green and blue visible colour respectively, when irradiated with UV.

In some embodiments, the three photoluminescent ink layers are each arranged to emit a red, yellow and blue visible colour respectively, when irradiated with UV.

In some embodiments, the security feature includes two photoluminescent ink layers, wherein each photoluminescent ink layer includes a fluorescent composition arranged to emit a coloured visible light when irradiated with UV.

In some embodiments, the two photoluminescent ink layers are configured to emit blue and yellow visible colour respectively, when irradiated with UV.

Preferably, colour mixing of the blue and yellow visible colours generates a white colour.

In some embodiments, the photoluminescent ink layers at least partially overlap in selected regions of the security feature, enabling colour mixing of the coloured visible light emitted by the fluorescent composition.

In some embodiments, the security feature includes an array of sub image regions, wherein the photoluminescent ink layers are selectively printed within the sub image regions in accordance with a desired colour appearance of the security feature when irradiated with UV.

In some embodiments, the photoluminescent ink layers do not overlap within the same sub image regions.

In some embodiments, the window region includes at least a full window, and/or a half window.

In some embodiments, the window region includes an edge window, or an edge to edge window of the security document.

In some embodiments, the security feature includes a metallic ink layer, at least partially overlapping the one or more photoluminescent ink layers.

In some embodiments, the metallic ink layer and the one or more photoluminescent ink layers are printed to simulate a visual appearance of a security thread, which has a narrow width and extends a substantial length or width of the security document.

In some embodiments, the metallic ink layer is printed to form a background of the one or more photoluminescent ink layers, such that the security feature displays a metal sheen when viewed under visible light.

In some embodiments, the security feature additionally includes at least one opacifying layer, at least partially overlapping the one or more photoluminescent ink layers.

In some embodiments, the security feature additionally includes at least one coloured ink layer, at least partially overlapping the one or more photoluminescent ink layers

In some embodiments, the at least one opacifying layer is overprinted onto the photoluminescent ink layers.

In some embodiments, the at least one opacifying layer is directly printed onto a transparent base film of the security document, and the photoluminescent ink layers are overprinted onto the at least one opacifying layer.

In some embodiments, the security feature displays a first image when viewed under visible light, and displays a second image when irradiated with the specified electromagnetic wavelength range.

In some embodiments, the second image is a coloured version of the first image.

In some embodiments, the second image is a multi colour version of the first image.

In some embodiments, the second image is a true RGB colour version of the first image.

In some embodiments, the second image is a distinct image that is not correlated with the first image.

In some embodiments, the first image is a vignette image which at least partially extends into the window region of the security document.

In some embodiments, the vignette image is at least partially formed by the at least one opacifying layer, wherein the at least one opacifying layer may be located on a same side of the transparent base film of the security document as the one or more photoluminescent ink layers, or on an opposite side of the transparent base film.

In some embodiments, the first image is a shadow image.

In some embodiments, the first image is a multi tonal image.

In some embodiments, the multi tonal image includes tonal variations across different regions of the first image, wherein the tonal variations are created by the at least one opacifying layer, and/or the one or more photoluminescent ink layers.

In some embodiments, the one or more photoluminescent ink layers, and the at least one opacifying layer have the same, or substantially similar colour appearances when viewed under visible light.

In some embodiments, the one or more photoluminescent ink layers, and the at least one opacifying layer both display a substantially white or grey colour appearance when viewed under visible light.

In some embodiments, at least one of the photoluminescent ink layers is at least partially directly printed onto a film surface of the security document.

In some embodiments, at least one of the photoluminescent ink layers is at least partially directly printed onto a transparent film surface of the security document, before other layers of the security document are introduced to the film surface.

In some embodiments, the opacifying layer(s), or the metallic ink layer are provided on the same side of the film surface as the one or more photoluminescent ink layers.

In some embodiments, when the security device is printed in a full window of the security document, it displays a multi-colour appearance when viewed from either side of the security document, when irradiated with the specified electromagnetic wavelength range.

In some embodiments, when the security device is printed in a full window of the security document, it displays a multi-colour appearance when viewed from either side of the security document, visible in both reflection and transmission viewing mode, when irradiated with UV.

In some embodiments, when the security device is printed in a half window of the security document, it displays a multi-colour appearance when viewed from a first side of the security document, and a monochromatic colour appearance when viewed from a second side of the security document, when viewed in reflection viewing mode with the specified electromagnetic wavelength range.

In some embodiments, when the security device is printed in a half window of the security document, it displays a monochromatic colour appearance when viewed from a first side of the security document, and a multi-coloured appearance when viewed from a second side of the security document, when viewed in transmission view mode with the specified electromagnetic wavelength range.

In some embodiments, the photoluminescent ink layers include titanium dioxide.

In a second aspect, the present disclosure provides a security document, comprising a security feature in accordance with the first aspect of the present disclosure.

In accordance with a second aspect the invention provides a method of printing a security feature on a substrate for a security document, the method comprising applying an ink according to any embodiment of the first aspect disclosed herein to the substrate.

Where the terms “comprise”, “comprises” and “comprising” are used in the specification (including the claims) they are to be interpreted as specifying the stated features, integers, steps or components, but not precluding the presence of one or more other features, integers, steps or components, or group thereof.

Further aspects of the invention appear below in the detailed description of the invention.

### BRIEF DESCRIPTION OF DRAWINGS

Embodiments of the invention will herein be illustrated by way of example only with reference to the accompanying drawings in which:

FIG. 1 shows a security document including a number of different embodiments of security features according to the present disclosure;

FIG. 2 shows a cross sectional schematic diagram illustrating layers of a security document;

FIG. 3 shows a cross sectional schematic diagram of a security document incorporating further embodiments of the present invention;

FIG. 4 shows a cross sectional schematic diagram of a security document incorporating further embodiments of the present invention;

FIG. 5 shows a cross sectional schematic diagram of a security document incorporating further embodiments of the present invention;

FIG. 6 shows a cross sectional schematic diagram of a security document incorporating further embodiments of the present invention;

FIG. 7 shows a cross sectional schematic diagram of a security document incorporating further embodiments of the present invention;

FIG. 8 shows a cross sectional schematic diagram of a security document incorporating further embodiments of the present invention;

FIG. 9 shows a cross sectional schematic diagram of a security document incorporating further embodiments of the present invention;

FIG. 10 shows a cross sectional schematic diagram of a security document incorporating further embodiments of the present invention

FIG. 11 shows a cross sectional schematic diagram of a security document incorporating further embodiments of the present invention;

FIG. 12 shows a cross sectional schematic diagram of a security document incorporating further embodiments of the present invention

FIG. 13 shows a security document including further embodiments of security features according to the present disclosure;

FIG. 14 shows a cross sectional schematic diagram of the layers of the security features illustrated in FIG. 13.

### DEFINITIONS

### Security Document

As used herein, the term security document includes all types of documents of value and identification documents including, but not limited to the following: items of currency such as bank notes, credit cards, cheques, passports, identity cards, securities and share certificates, driver's licences, deeds of title, travel documents such as airline and train tickets, entrance cards and tickets, birth, death and marriage certificates, and academic transcripts.

### Substrate

The use of plastic or polymeric materials in the manufacture of security documents pioneered in Australia has been very successful because polymeric banknotes are more durable than their paper counterparts and can also incorporate windows and other more advanced security features. The substrate may thus be a plastic or polymeric material including but not limited to polypropylene (PP), polyethylene (PE), polycarbonate (PC), polyvinyl chloride (PVC), polyethylene terephthalate (PET), or a composite material of two or more such materials. In some embodiments, the substrate is a transparent polymeric material. A particularly suitable transparent substrate is polypropylene and in particular bi-axially oriented polypropylene (BOPP).

In some embodiments, the substrate is an opaque polymeric substrate. Examples and methods of construction of such opaque polymeric substrates are for example provided in applicant's Australian patent application 2017901840. The opaque polymeric substrate is opacified during manufacture of the film itself by inclusion of an opacifying additive into the polymer during extrusion. The polymer film is thus opacified due to its bulk properties rather than due to addition of opacifying layers. One such example of a suitable polymer film is a bi-axially oriented polypropylene (BOPP) which has titanium dioxide particles added during manufacture to create a white polymer film.

In some embodiments, the substrate is from 60 to 100 microns thick, preferably from 65 to 90 microns thick.

### Window

One common security feature in polymeric banknotes produced for Australia and other countries is a transparent area or “window”. Transparent polymeric substrates for banknotes are commonly opacified by the application of at least one pigmented opacification layer, and typically multiple overlying opacification layers on each side. In this scenario, a full window is provided by entirely omitting the opacifying layers on both sides of an area of the transparent substrate. A partly transparent or translucent area, hereafter referred to as a “half-window”, may also be formed by partially or completely omitting the opacification layers on one side only.

Alternatively, a window may be produced by including a transparent polymeric substrate as an insert in a cut out section of an opaque substrate.

As used herein, edge windows are windows which extend to an edge of the banknote, while edge-to-edge windows extend across the width of the bank note from one edge to the opposite edge. Larger-sized windows on bank notes, including edge and edge-to-edge windows, are increasingly popular as they increase the level of security.

The term ‘window’ or ‘window region’ is used in this specification to refer to all the different types of full, half, or edge-to-edge windows as described above.

### Opacification

The opacified regions of bank notes produced on a transparent polymeric substrate typically comprise at least one printed opacification layer, with printed design features or security features then applied on top. Typically, multiple overlaid opacification layers are sequentially printed to provide a suitable pigment density for opacification. In other cases, as already noted, a polymer film is opacified during its manufacture by inclusion of an opacifying additive into the polymer melt for extrusion into film.

The opacification layers or opacified film may comprise any opacifier which suitably opacifies the substrate, as perceived by a viewer. The opacifier is typically a pigment in the form of a particulate material, which is dispersed or bound in a polymeric matrix or binder. The pigment particles may optionally be coated or otherwise surface-modified to improve their dispersibility.

The opacification layers may comprise a pigment that is substantially non-absorbent of visible light, but which opacifies the substrate by scattering and/or refracting visible light. Unless other colouring agents are also included, transparent substrates overlaid with opacification layers of sufficient combined thickness and pigment density will appear white to a viewer when viewed in natural light, since a wide range of visible light wavelengths are substantially reflected from the substrate as a result of light scattering by the pigment particles.

Scattering (white) pigments generally have a high refractive index relative to the matrix in which they are dispersed. Furthermore, it will be appreciated that the particle size of the pigment affects scattering power. Refractive particles scatter light optimally when the primary particle size is approximately half the wavelength of the light. Since the human eye is most sensitive to yellow-green light, with a wavelength of around 550 nm, pigment particles with a particle size of 200-300 nm are considered optimal opacifiers in the art. The pigment particles may therefore have particle sizes predominantly in a range of from 150 nm to 500 nm, such as from 200 nm to 400 nm. Particles smaller than about 100 nm may be too small to effectively scatter visible light.

A particularly suitable pigment for opacification of film substrates according to the invention is particulate titanium dioxide, preferably with a high content of rutile phase (although anatase is also considered to be effective). Rutile titanium dioxide has a higher refractive index (2.73) compared with many other white pigments. Although titanium dioxide is thus preferred, other opacifier pigments such as antimony oxide, zinc oxide, calcium carbonate, magnesium silicate (talc) and the like may also be used.

Throughout this specification, terms such as “opacification layer(s)”, “opacifying coating(s)” and “opacifying layer(s)” have the same meaning and are used interchangeably.

### Print Processes

For the traditional banknote industry, the typical print processes are sheet-fed offset and sheet-fed intaglio printing. Thus, a banknote substrate is supplied in sheets to an offset print press and then, separately, to an intaglio print press. Other print process types which are commonly found both inside and outside the security industry are letterpress, gravure, flexographic and ink jet. All of these print processes require particular types of substrate supply, print equipment and inks.

Print processes in which a web of the substrate is fed through a print press comprising successive print units offer a number of advantages over sheet fed processes, in particular the greater speed of printing. The print process types which can run at the highest speeds, and therefore lowest costs, in a web-fed print process are flexographic and gravure printing.

Although the term “intaglio printing” can be used generically to cover all printing techniques in which an image is incised into a surface and the incised line or sunken area holds the ink for printing, in the art of security printing a distinction is made between gravure (also known as rotogravure) and intaglio (also known as line intaglio) print process types. The skilled person in the art of security printing would immediately understand that an intaglio print process for printing a security document involves high viscosity ink applied to lines incised into an intaglio print plate which is applied at great pressure to the substrate. Likewise, the skilled person in the art of security printing would immediately understand that a gravure print process for printing a security document refers to lower viscosity inks captured from a bath of ink by a cylinder with “cells” engraved in the cylinder and applied to a substrate.

### DETAILED DESCRIPTION

The present disclosure relates to photoluminescent security features, security documents including such photoluminescent security features, and methods of producing the photoluminescent security features on security documents. The photoluminescent security features are, preferably, security features which phosphoresce or fluoresce in response to electromagnetic radiation and, most preferably, which fluoresce in response to Ultra Violet (UV) electromagnetic radiation. The following description will describe fluorescing security features which respond to UV illumination, but phosphorescing and fluorescing security features which respond to other ranges of electromagnetic radiation are also applicable to the embodiments described below.

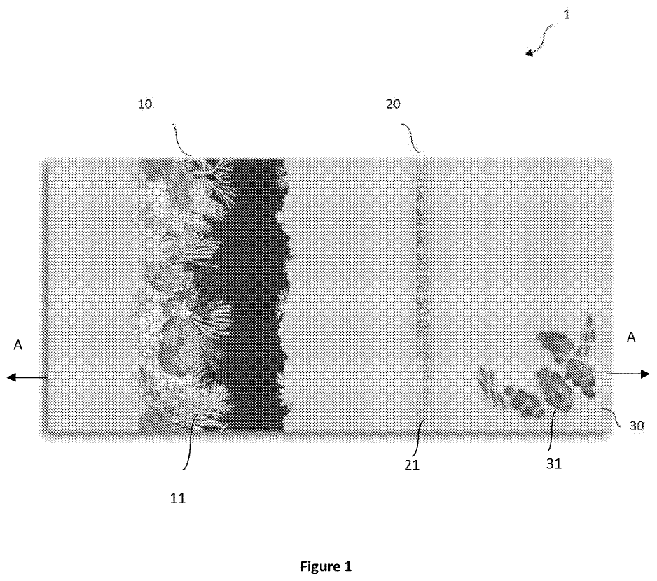

Embodiments of the invention will now be described with reference to FIGS. 1 to 14, which depict a security document 1, including a transparent polymeric film 40, coated with a plurality of opacifying layers on each side of the polymeric film 40. In some configurations, two opacifying layers 101, 102 are printed on a first surface of the polymeric film 40, and further opacifying layers 104, 105, 106 are printed on a second surface of the polymeric film 40. The number of opacifying layers provided on each side of the polymeric film 40 may vary in some embodiments, and not necessarily limited to the same number of layers as illustrated in FIGS. 1 to 14.

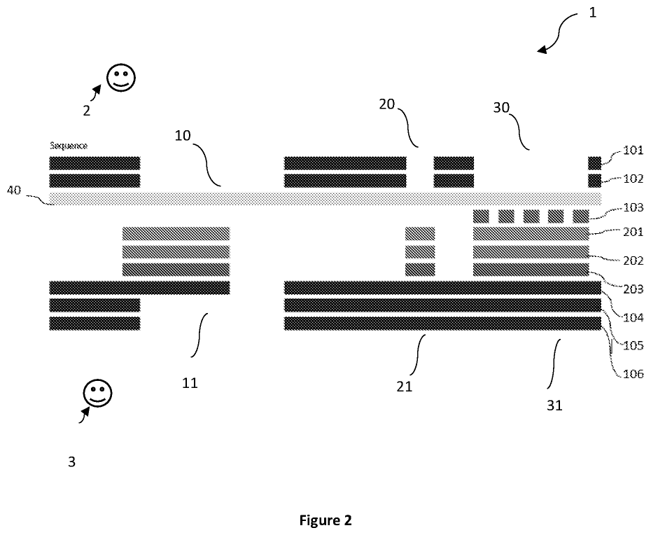

As illustrated in FIG. 2, the opacifying layers 101 to 106 are omitted in selected regions of the security document 1, in order to form window regions 10, 20, and 30 respectively. Although the embodiments disclosed herein indicate that a plurality of window regions are formed in the security document 1 across different locations, it will be understood that the location and varying sizes of these window regions are shown for illustration purposes only. In at least some embodiments, a single, or two or more window regions may be formed in the security document 1, each of which includes one or more of the fluorescing security features disclosed herein.

FIG. 1 shows a plan view of the security document 1, including three window regions 10, 20, 30, within which security features 11, 21, and 31 are formed respectively. FIG. 2 shows a cross sectional schematic diagram showing the layers of the security document 1, along line A-A.

As illustrated in FIGS. 1 and 2, the security feature 11 is at least partially, or substantially formed in the window region 10 of the security document 1. In this embodiment, the window 10 is a full transparent window. The security feature 11 includes three fluorescing ink layers 201, 202, and 203, each including a composition capable of emitting a visible light when irradiated with UV illumination. For example, the fluorescing ink layers 201-203 may be arranged to emit red, green, and blue visible colour respectively. In other embodiments, the fluorescing ink layers 201-203 may be arranged to emit red, yellow, and blue coloured visible light respectively. The plurality of fluorescing ink layers 201-203 coordinate with each other, to generate a multi coloured appearance of the security feature 11 when exposed to UV. It is known that a multi coloured image may be separated into three colour channels, such as Red (R), Green (G), and Blue (B). Accordingly, once a desired colour appearance of the security feature 11 is decided, the corresponding fluorescing ink layers 201-203, and their printing location on the polymeric film surface can also be determined.

There are a number of different ways to print the plurality of fluorescing ink layers 201-203, to allow them to achieve colour mixing effect as mentioned above. One available option is to print the fluorescing ink layers 201-203 such that they overlap in selected regions of the security feature 11. When exposed to UV illumination, the overlapping fluorescing ink layers 201-203 react to the UV wavelengths and emit visible colour wavelengths substantially at the same time, such that the perceived colour is a mixture of all the visible colour wavelengths emitted by the different fluorescing ink layers 201-203.

In some embodiments, the security feature 11 comprises two fluorescing ink layers only, each including a composition capable of emitting a visible light when irradiated with UV illumination. For example, the fluorescing ink layers may be arranged to emit yellow and blue visible colour respectively. In regions where the two fluorescing ink layers overlap, colour mixing of yellow and blue results in a glowing white colour. This may be used to create a security which appears substantially white under normal lighting conditions, but the white colour glows brightly when irradiated with UV.

In some configurations, the fluorescing ink layers 201-203 may each be arranged in selected areas of a window such that there is no overlapping between the different fluorescing ink layers. When printed this way, the colour mixing effects of the fluorescing ink layers 201-203 is eliminated, thereby generating a multicolour image that comprises the individual colour of each of the fluorescing ink layers 201-203 only. In some instances, the multicolour image consists of three primary colours only, namely, red, green, blue. In some instances, the multicolour image consists of red, green, and yellow.

Alternatively, or in addition, the security feature 11 may be divided into an array of sub image regions, for example, an array of sub image pixels. The inks of the fluorescing ink layers 201-203 may be selectively deposited into the sub image regions according to the desired colour appearance of the security feature 11. With this approach, the inks of the different fluorescing ink layers 201-203 may not overlap within a selected sub image region. Instead, the inks of the different fluorescing ink layers 201-203 are deposited very close to each other, and are preferably deposited to form patterns that are not discernible to naked eye (e.g. to form an array of discrete dots). When the security feature 11 is exposed to UV illumination, colour mixing effect of the fluorescing ink layers 201-203 will still take place for each of the sub image regions, such that security feature 11 displays a multi-coloured appearance when exposed to UV illumination. In some embodiments, a combination of the different approaches mentioned above may both be used to produce a desired colour appearance of the security feature 11, as well as other security features described below.

In FIG. 2, the security feature 11 also includes an opacifying layer 104 overprinted on top of the fluorescing ink layers 201 to 203 within the window 10. The opacifying layer 104, and the fluorescing ink layers 201-203 are printed such that they create a first image appearance, as shown in FIG. 1, which acts as a first authenticatable feature of the security feature 11. This first image may be visible under ordinary lighting conditions as a vignette image that extends into the window region 10, a multi-tonal image, or any other desirable image appearances. The term ‘vignette image’ refers to an image that has a unique edge, and the image is usually at least partly provided in a window region. Preferably, the fluorescing ink layers 201-203 have the same colour appearance as the opacifying layers 101-106 under ordinary lighting conditions (i.e. under visible light). That is, they all display a substantially white or pale grey colour. When irradiated with UV illumination, the security feature 11 displays a second image appearance, which may be a multi-coloured version of the first image, due to the fluorescing ink layers 201-203. This second multi coloured image can then act as a second authenticable feature of the security feature 11, thus making it more difficult to counterfeit. In the example shown in FIGS. 1-2, the security feature 11 shows an image of an aquarium, under ordinary lighting conditions. When exposed to UV illumination, the plants and fish of the aquarium become multi coloured, creating a more vivid appearance of the aquarium.

In another embodiment, the security feature 11 may be configured such that it displays a first image under ordinary lighting conditions, and a second image when irradiated with UV illumination, wherein the second image forms a distinct image appearance itself.

FIGS. 1 and 2 additionally show a second embodiment of the security feature 21, which is formed to simulate the appearance of a conventional security thread. The security feature 21 extends from a top edge to a bottom edge of the security document 1, and optionally being parallel to a left or a right side edge of the security document 1. In addition, the width of the security feature 21 may be less than 10 mm, or less than 8 mm, or less than 5 mm, or less than 3 mm, such that it resembles the appearance of a conventional security thread. The security feature 21 displays a series of number “50”, being the denomination of the security document 1. When viewed under ordinary lighting conditions, the security feature 21 does not have any colour variation, appearing as a simple printed security thread. When viewed under UV illumination, the plurality of “50”s may show a range of different colours, due to the fluorescing ink layers 201-203, creating a multi-colour appearance for the security feature 21.

FIGS. 1-2 show a further embodiment of the security feature 31, which includes an opacifying layer 103 that is printed to form a shadow image. By ‘shadow image’ it is meant that the image becomes more obvious, or reveals itself, when it is examined in transmissive viewing mode (i.e. by holding the banknote against a light source), but is generally less obvious or hidden when it is viewed in reflection. A positive shadow image is usually created by increasing the opaqueness of the security document 1, through printing one or more additional opacifying layers in accordance with an image pattern. Similarly, a negative shadow image may be created by reducing the opaqueness of the security document 1, through omitting the one or more additional opacifying layers in accordance with an image pattern. For security feature 31, the opacifying layer 103 may be created to form an outline, and/or patterns of the plurality of fish shown in FIG. 1. The fluorescing ink layers 201-203 may then be printed to create the vibrant colours of the fish that are visible when exposed to UV illumination.

As illustrated in FIGS. 1 and 2, the security features 11, 21, and 31 are printed such that the fluorescing ink layers 201-203 are all located on the lower surface of the polymeric film 40, with the upper surface of the polymeric film 40 not being covered by any ink layers in the window regions 10, 20, 30. This allows authentication of the security features 11, 21, and 31 from both surfaces of the security document 1, as will be explained below, which is a significant improvement compared to the UV security features previously provided on paper based banknote substrates.

When the security document 1 is exposed to UV illumination, the fluorescent composition of the fluorescing ink layers 201-203 absorbs, or otherwise reacts to the UV illumination, and emits visible colour wavelengths, which can transmit through the polymeric film 40, to be visualised by viewer 2. From the viewing position of viewer 3, as the fluorescing ink layers 201-203 are overprinted by one or more opacifying layers 104-106, some of the visible colour wavelengths generated may be filtered or absorbed by the opacifying layers 104-106. Accordingly, when viewed from lower surface of the security document 1 (i.e. from the position of viewer 3), the colour appearance of the security features 11, 21, 31 can be different and may display a monochromatic image appearance.

In at least some embodiments, the fluorescing ink layers 201-203 may be arranged such that the intensity of visible wavelengths of light emitted by each layer is different when exposed to UV. For example, the fluorescing ink layer 203 may be selected to emit red visible light when illuminated with UV, and/or the intensity of red light may be greater than the intensity of light generated by the other two fluorescing ink layers 201 and 202. In this instance, when the security features are viewed from the position of view 3, particularly when viewed in reflection, the security features 11, 21 and 31 may display a red monochromatic appearance.

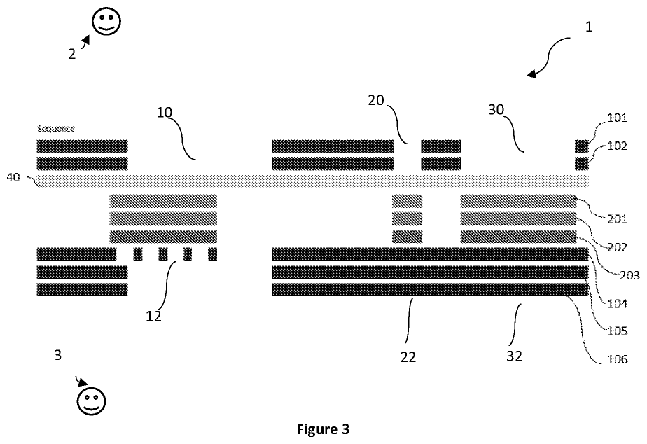

In a further embodiment, the security feature may be configurated such that it displays a multi coloured appearance under UV illumination, that is visible from both surfaces of the security document 1. Preferably, the multi coloured appearance under UV illumination is substantially the same when viewed from either side of the polymeric film 40. An example of this embodiment is illustrated in FIG. 3, as security feature 12.

Similar to previous embodiments, the security feature 12 includes three fluorescing ink layers 201-203, each including a fluorescent composition which emits a selected visible colour wavelength when irradiated with UV light. The fluorescing ink layers 201-203 are arranged to each emit a primary visible colour red, green, or blue, however other choices of colours may also be selected, depending on the imagery design and colour preference. Within the window region 10, an opacifying layer 104 is printed to partially overlap with the fluorescing ink layers 201-203, to form a shadow image, perceivable under ordinary lighting conditions. When examining the security feature 12 from the position of viewer 2, a shadow image may be observed when viewing in transmission. In reflective viewing mode, the shadow image created by the opacifying layer 104 may be concealed by the fluorescing ink layers 201-203 such that it is hidden from viewer 2. When viewed from the opposite side, from the position of viewer 3, the shadow image may be perceivable in both transmission and reflection. In this configuration, the colours generated by the fluorescing ink layers 201-203 are able to be transmitted through the transparent polymeric film 40 from a top surface, or through the opacifying layer 104 from a lower surface, such that it displays a multi coloured appearance from both sides of the security document 1.

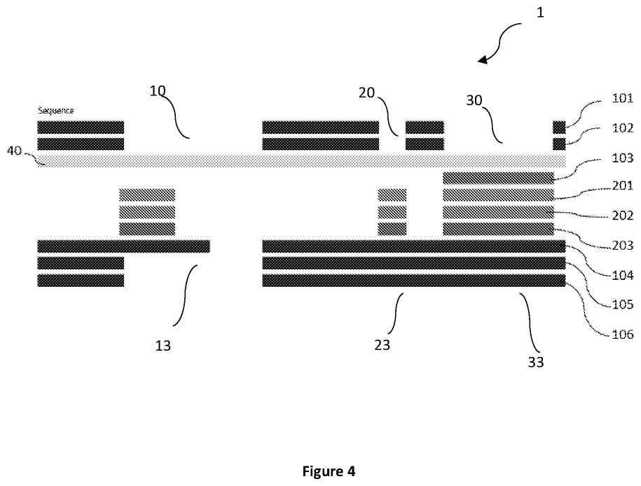

FIG. 4 shows a further embodiment of a security feature 13 formed in the window region 10 of the security document. In this embodiment, the opacifying layer 104 is applied such that it extends into the window region 10, and again forms at least part of a vignette image (for example, an aquarium) that is visible under normal light conditions. The fluorescing ink layers 201-203 overlap with the opacifying layer 104 within the window region 10, which may contribute to tonal variations of the vignette image under ordinary viewing conditions. That is, a multi-tonal vignette image may be displayed in the window 10 under ordinary viewing conditions. When irradiated with UV, the security feature 13 displays a multi-coloured image appearance.

FIGS. 2, 3, 4 demonstrate the flexibility of arranging fluorescing ink layers 201-203, and the opacifying layer 104 when forming a security feature within a full or half window. Depending on design preferences, the fluorescing ink layers 201-203 and the opacifying layer 104 can be configured to create a desired first image that is observable under ordinary conditions, and portions, or the entire first image may glow a range of different colours when irradiated with UV, to generate a second image. The amount of overlap between the fluorescing ink layers 201-203 and the opacifying layer 104 can also vary in different embodiments. For example, in FIG. 2, the fluorescing ink layers 201-204 and the opacifying layer 104 are arranged such that they substantially overlap in the window 10. In FIG. 3, the opacifying layer 104 is overprinted onto the three fluorescing ink layers 201-203 such that a multi tonal image is created, due to variations in optical density created by the plurality of ink layers 201-203, 104. In FIG. 4, the opacifying layer 104 is printed to form a vignette image in window 10, whereas the fluorescing ink layers 201-204 are printed to overlap with selected regions of the opacifying layer 104 in the window 10, to generate colours in these regions.

In the embodiments illustrated in FIGS. 2 and 4, the vignette image formed by the opacifying layer 104 and the fluorescing ink layers 201 to 203 are all located on the second surface of the substrate 40. It will be appreciated that in at least some embodiments, the vignette image can be formed by one or more opacifying layers located on a second surface of the polymer substrate 40, such as by opacifying layers 101 and 102. In other embodiments, the vignette image may be formed by opacifying layers located on both of the first and second surfaces o the substrate 40.

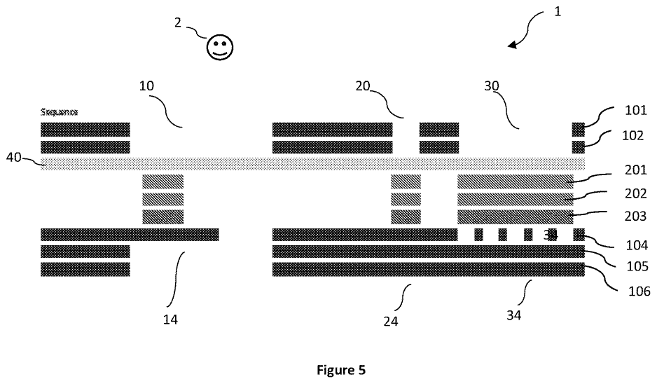

As mentioned above, a negative shadow image may be created by reducing the opaqueness of the security document 1, by reducing the opacifying of the security document in selected areas through omitting the one or more opacifying layers in accordance with an image pattern. An example of this is shown in FIG. 5, in window 30, in which the opacifying layer 104 is selectively omitted in selected regions of the half window region 30 in accordance with a desired image pattern. Under ordinary light conditions, when viewed in transmission, the layers 201-203, 104-106 coordinate with each other to create a negative shadow image within window region 30. When irradiated with UV illumination, a multi-coloured image appearance is displayed due to the fluorescing ink layers 201-203.

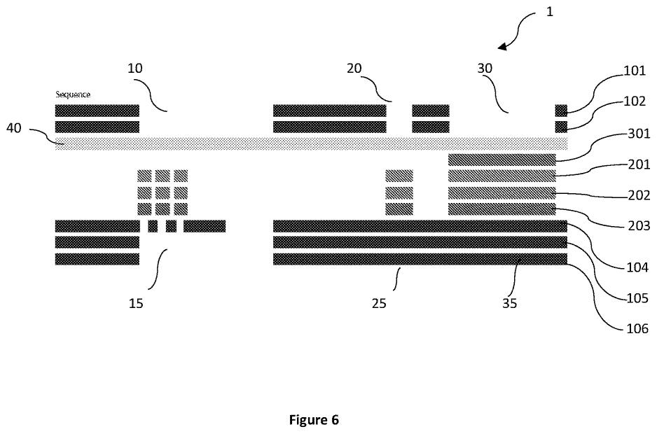

FIG. 6 shows further embodiments of security features 15, 25 and 35. An ink layer 301 may be printed within the half window region 30, before the fluorescing ink layers 201-203 are applied to the polymeric film 40, and further opacifying layers 104-105 are then applied onto the lower surface of the polymeric substrate 40. The ink layer 301 may be printed using a coloured ink, that typically has a higher opacity than each of the opacifying layers 101-102, 103-106. Alternatively, the ink layer 301 may be another opacifying layer, similar or identical to other opacifying layers 101-102, 104-106.

In one form, the ink layer 301 may be printed to form a multi tonal image, wherein tonal variations of the image are formed by halftoning within the single layer of ink. ‘Halftoning’ is an image creation technique that simulates tonal variations, through the use of an array of micro image icons, such as dots, lines, that vary in size, spacing, and/or density, thereby generating a gradient like effect. The resulted security feature 35 may display a monochromatic, multi-tonal appearance under ordinary viewing conditions. When irradiated with UV, the security feature 35 may display a multi coloured appearance due to the fluorescing ink layers 201-203, similar to previous embodiments. Alternatively, the ink layer 301 may be printed to form a mono tonal image.

FIG. 6 also shows a further embodiment of a security feature 15 within a full window region 10 of the security document 1. In previous embodiments, such as security feature 11, 12, 13, 14, the fluorescing ink layers 201-203 are generally applied as continuous, or substantially continuous ink layers. This allows the overlapping fluorescing ink layers 201-203 to create a multi-tonal appearance when viewed under ordinary lighting conditions, if desired. Further, it also reduces registration requirements between different layers.

FIG. 6 shows an alternative embodiment of a security feature 15, positioned in a full window 10, in which the fluorescing ink layers 201-203 are printed such that they are in discrete areas within the window 10, meaning each of the fluorescing ink layers 201-203 is directly printed onto a lower surface of the polymeric film, rather than overlapping with each other. This configuration eliminates the need of viewing UV colours through overlapping layers, which may result in stronger colour appearances when the window 10 is irradiated with UV. When there is no overlapping between the fluorescing ink layers 201-203, they must be printed such that they are registered with each other, meaning the relative displacement between the layers is within a predetermined registration tolerance. This ensures that the layers 201-203 could still coordinate with each other to create a first image appearance when the area is viewed under ordinary lighting conditions. The registration tolerance may between 100 um to 1000 um, or preferably between 200 um and 800 um, or between 250 um and 750 um, or between 300 um and 600 um, or between 300 and 500 um, when the fluorescing ink layers are printed on a gravure print press.

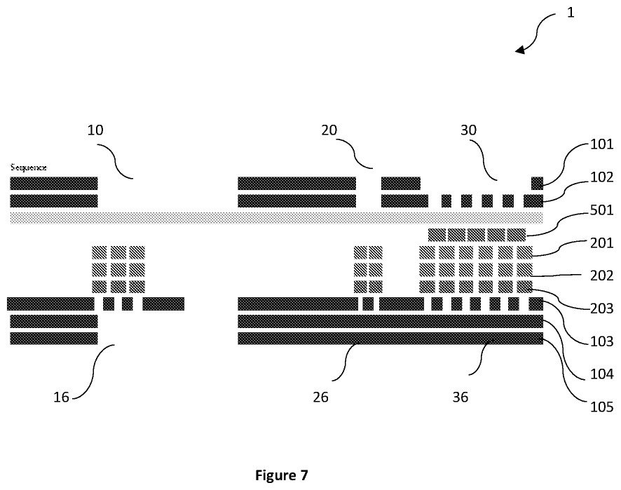

FIG. 7 shows further embodiments of security features 16, 26, and 36 according to the present disclosure. To further increase the complexity of the security features and therefore making them more difficult to counterfeit, more image layers may be incorporated. For example, the security feature 36 comprises three fluorescing ink layers 201-203, and a plurality of ink layers 102, 501, 103 disposed on either side of the fluorescing ink layers 201-203. The ink layer 102 may be an opacifying layer, printed to form an image, or as an array of screen elements. The ink layer 501 may be another opacifying layer, or a coloured ink layer, printed to form a positive shadow image, or a multi-tonal image. The ink layer 103 is another opacifying layer and may be printed to form a vignette image, a negative shadow image, or it may simply include regions in which the ink is omitted to reduce the opacity in those regions.

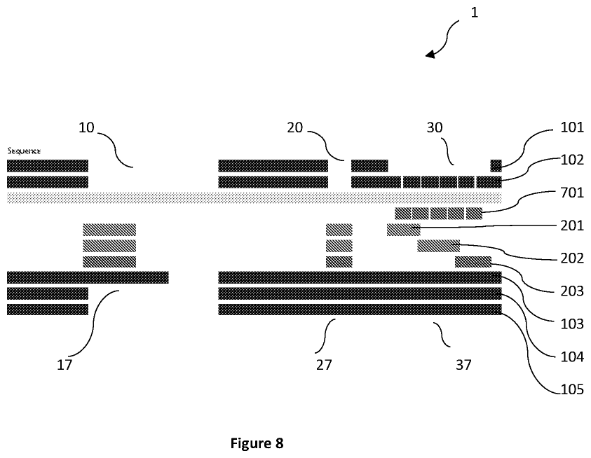

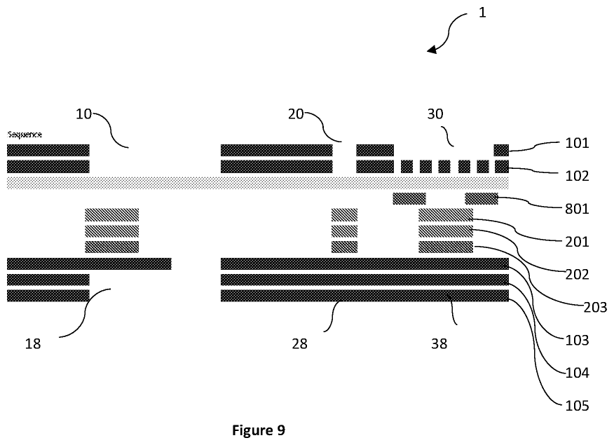

FIG. 8 shows further embodiments of security features 17, 27, and 37. As discussed above, one option of creating the colour mixing effects of the fluorescent ink layers 201-203 is to overlap two or more of the fluorescent ink layers at desired locations. FIG. 8 illustrates an embodiment of a security feature 37, which includes three fluorescing ink layers 201-203 that are printed in discrete regions within the window 30, such that they do not directly overlap with each other, therefore there is no colour mixing between the fluorescing ink layers 201-203. Three opacifying layers 103-105 are then overprinted onto the lower surface of the fluorescing ink layers 201-203. When irradiated with UV, the security feature 37 displays a multi-coloured image that comprises the colours of each of the fluorescing ink layers 201-203 only. An additional ink layer 701 may also be provided in the window 30, which may be an opacifying layer, or a coloured ink layer, that is printed to form an image. The ink layer 701 may be printed such that it substantially overlaps with the fluorescing ink layers 201-203 within the window 30. Alternatively, a coloured ink layer 801 may be printed around a perimeter of the fluorescing ink layers 201-203, such as illustrated in FIG. 9.

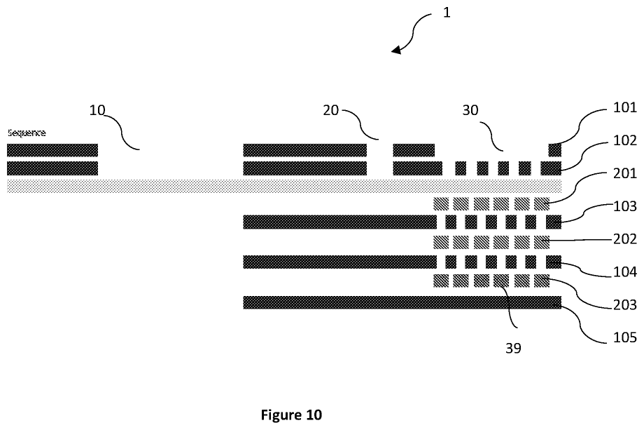

In some configurations, the plurality of the fluorescing ink layers 201-203 are printed consecutively onto the polymeric film surface first, before other layers are applied. However this is not always the case. FIG. 10 illustrates an alternative embodiment in which each of the opacifying layers 103, 104 is sandwiched between two adjacent fluorescing ink layers.

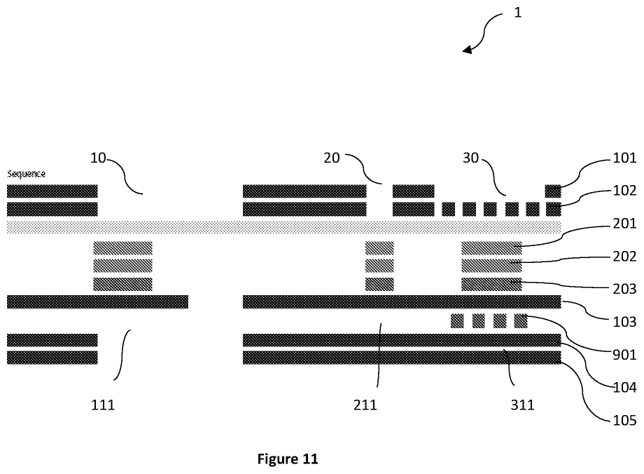

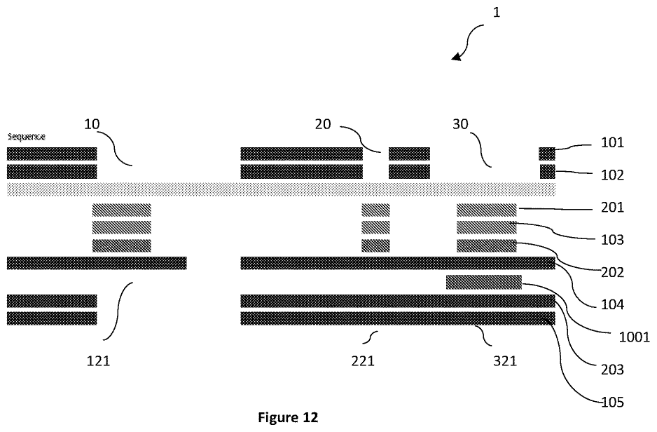

Alternatively or in addition, a coloured ink layer 901, 1001, may be sandwiched between two adjacent opacifying layers 103, 104, as illustrated in FIGS. 11 and 12. The coloured ink layer 901, 1001 may be printed to form an image, or as a background colour in these embodiments.

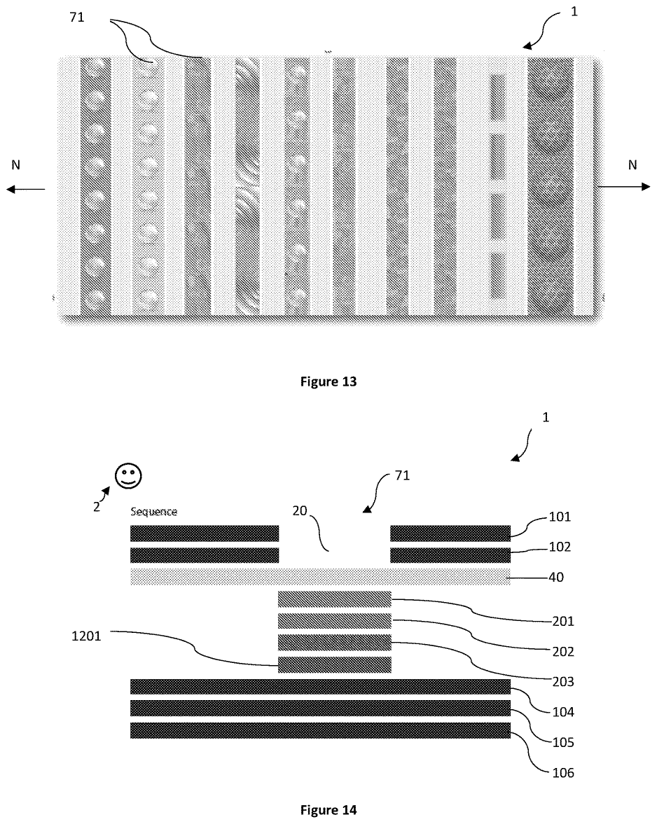

FIG. 13 shows a plurality of security features 71 which are all formed to simulate the appearance of conventional security threads. Conventional security threads are often produced separately from paper banknotes, and are either attached, embedded, or woven into the substrates of paper banknotes at a suitable stage of the manufacturing process. Sometimes the threads are required to be woven into the paper banknotes during the paper making process. Security threads are widely used as security features on paper banknotes so they are well accepted by the general public. However, when a polymeric film is used to produce the substrate of a security document, this conventional approach can no longer be adopted easily, due to differences between paper and polymeric materials.

With reference to FIG. 14, the security feature 71 includes three fluorescing ink layers 201-203, and a metallic ink layer 1201 overprinted onto the fluorescing ink layers 201-203, to create an appearance similar to that of a silver foil. In an alternative embodiment, the metallic ink layer 1201 may be printed onto the lower surface of the polymeric film 40 first, before the fluorescing ink layers 201-203 are applied. In some embodiments, the metallic ink layer 1201 creates a metal sheen, and comprises a colour that visually contrasts with the colour of the opacifying layers and the fluorescing ink layers 201-203. The metallic ink layer 301 may be printed to form a background of the fluorescing ink layers 201-203, or form part of the thread design itself. When viewed from a top surface of the security document 1, under ordinary lighting conditions, the security feature displays an appearance similar to that of a conventional thread. Under UV illumination, the fluorescing ink layers 201-203 will emit visible colour wavelengths, changing the appearance to a coloured thread.

### Fluorescent Compositions

The fluorescing ink layers 201-203 are preferably printed by an ink formulation that comprises a fluorescent composition. Fluorescent compositions may comprise a range of fluorescent pigments or dyes capable of emitting visible light when irradiated with UV illumination. The fluorescent composition may emit visible light when irradiated with UV light in the range of 300 nm to 390 nm, such as around 365 nm as used in many UV-detection systems for authentication purposes. An example UV lamp is a Kruss UV240 which is often used to visualise the fluorescence of security features which respond to UV light.

The fluorescent composition may comprise an organic fluorescent material, including derivatives of polycyclic aromatic molecular structures such as perylene, pyrene and the like. Perylene dicarboximide dyes, for example, can be derivatised to emit a range of different visible light colours when irradiated with UV light. Moreover, organic fluorescent dyes may be incorporated in or covalently grafted onto polymeric or other support matrices to provide particulate fluorescent pigments.

In some embodiments, the fluorescent composition may comprise a fluorescent pigment, a suitable example of which is LU0012, LUPCZ2, LUNAR2, or LUCR from Luminochem or SC-25, SC-6, SC-31, SC-17 from Angstrom Technologies. Other similar fluorescent pigments may be used instead of the examples listed herein.

### Ink Formulations

The fluorescing ink according to the invention comprise a fluorescent composition, as described herein.

In some embodiments, the yellow/green fluorescent composition may be present in the ink at a weight loading of 4 wt % but can also be between about 1 wt % and about 10 wt %. When a blue fluorescent composition is used, the fluorescent pigment may present in the ink at a loading of about 2 wt %, but can also be between 1 wt % and 10 wt %. When a red fluorescent composition is used, the fluorescent pigment may present in the ink at a loading of about 5 wt %, but can also be between 1 wt % and 10 wt %.

The inks further comprise, in addition to the fluorescent compositions, a carrier fluid in which the functional components (e.g. the fluorescent compositions) of the ink are dispersed to allow the ink to be printed. The carrier fluid is generally present in a sufficient quantity to disperse the ink components and to provide a target print viscosity.

The carrier fluid typically includes one or more organic solvents. In some embodiments, the carrier fluid comprises at least one ester or ketone solvent, for example propylene glycol monomethyl ether acetate (PGMA) and methyl ethyl ketone.

The inks may further comprise a binder (also known as a vehicle), such as a resin or polymeric material, that retains the fluorescent compositions, and adheres the printed ink layers to the polymeric film once dried and/or cured. Suitable binders for these purposes are known to those skilled in the art of security printing. In some embodiments, the binder is capable of cross-linking during or after printing, for example induced by oxidation, thermal treatment, or exposure to UV or other actinic illumination.

In some embodiments, the fluorescing inks may further comprise a cross-linking agent and/or a catalyst to induce cross-linking of the binder upon curing of the ink. The inks may also comprise other conventional components, such as a dispersing agent.

The inks may be formulated for printing via a variety of different techniques, including for example but not limited to gravure, flexographic, intaglio, and offset printing. In some embodiments, the ink is formulated for gravure printing, and in particular for gravure printing in a high speed web-based printing process. Such inks may have a viscosity in the range of from 19 to 22 sec as measured using a Zahn Cup #2 (approximately 25 to 40 centipoise). In other embodiments, the ink is formulated for off-set printing, and in particular for offset printing in a high speed web-based printing process.

### Methods of Printing a Security Feature on a Substrate for a Security Document

The invention also relates to methods of printing a security document with the inks disclosed herein. The inks may be applied to a substrate by any suitable technique, which in some embodiments is gravure or offset printing, and in particular gravure printing.

In some embodiments, the inks may be printed onto a web of polymeric substrate in a print press comprising one or more print units through which the web is fed during a print run. It will be appreciated that different inks according to the invention, for example inks with differing colouring agents or fluorescent compositions, may be printed at multiple such print units along the web. Furthermore, a wide variety of other conventional printing operations may be performed at other print units and stations along the web. Examples of such operations, for the specific case where the web is a transparent polymeric substrate, include surface treatment to improve adhesion (such as corona discharge treatment), printing of multiple successive opacification layers, gravure printing of design elements comprising one or more coloured inks, application and embossing of UV-curable lacquers to form optically active embossed features, and the like.

The inks may be printed or otherwise applied at a suitable coat weight for the print technique of choice. It will be appreciated that the loading of the functional ink components in the resulting print layer will directly depend on the applied coat weight. For gravure printing, a suitable wet coat weight may be from about 2 g/m 2 to 10 g/m², for example approximately 6 g/m². The printed ink may then be dried and/or cured on the substrate by conventional means, including via heating applied by a drying unit or via exposure to actinic illumination, for example UV-light. The resulting print layer may have a thickness of in the range of about 100 nm to about 3 microns, typically between 1 and 3 microns.

Those skilled in the art will appreciate that the invention described herein is susceptible to variations and modifications other than those specifically described. It is understood that the invention includes all such variations and modifications which fall within the spirit and scope of the present invention.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or invention.

1. A security feature for a security document, the security feature comprising:
one or more photoluminescent ink layers, each including a composition capable of emitting visible light when irradiated with a specified electromagnetic wavelength range, wherein the one or more photoluminescent ink layers are at least partially printed in a window region of the security document; and
at least one opacifying layer, at least partially overlapping the one or more photoluminescent ink layers,
wherein the one or more photoluminescent ink layers and the at least one opacifying layer have the same or substantially similar colour appearances when viewed under visible light.

2. The security feature of claim 1, wherein the one or more photoluminescent ink layers are fluorescing ink layers, or phosphorescing ink layers.

3. (canceled)

4. (canceled)

5. The security feature of claim 1, wherein the security feature includes three photoluminescent ink layers, wherein each photoluminescent ink layer includes a fluorescent composition arranged to emit a coloured visible light when irradiated with UV.

6. The security feature of claim 5, wherein the three photoluminescent ink layers are each arranged to emit a primary visible colour when irradiated with UV.

7. (canceled)

8. (canceled)

9. The security feature of claim 1, comprising a plurality of photoluminescent ink layers, wherein the photoluminescent ink layers at least partially overlap in selected regions of the security feature, enabling colour mixing of the coloured visible light emitted by the fluorescent composition.

10. The security feature of any claim 9, wherein the one or more photoluminescent ink layers include two photoluminescent ink layers, wherein each photoluminescent ink layer includes a fluorescent composition arranged to emit a coloured visible light when irradiated with UV.

11. The security feature of claim 10, wherein the two photoluminescent ink layers are arranged to emit a blue and a yellow visible colour respectively, when irradiated with UV, wherein colour mixing of the blue and yellow visible colours produces a white luminescent colour.

12. (canceled)

13. The security feature of claim 1, wherein the security feature includes an array of sub image regions, wherein the photoluminescent ink layers are selectively printed within the sub image regions in accordance with a desired colour appearance of the security feature when irradiated with UV.

14. (canceled)

15. (canceled)

16. (canceled)

17. The security feature of claim 1, wherein the security feature includes a metallic ink layer, at least partially overlapping the one or more photoluminescent ink layers.

18. The security feature of claim 17, wherein the metallic ink layer and the one or more photoluminescent ink layers are printed to create a visual appearance of a security thread, which has a narrow width and extends a substantial length or width of the security document.

19. The security feature of claim 17, or wherein the metallic ink layer is printed to form a background of the one or more photoluminescent ink layers, such that the security feature displays a metal sheen when viewed under visible light.

20. (canceled)

21. The security feature of claim 1, wherein the at least one opacifying layer is overprinted onto the photoluminescent ink layers; or wherein the at least one opacifying layer is directly printed onto a transparent base film of the security document, and the photoluminescent ink layers are overprinted onto the at least one opacifying layer.

22. (canceled)

23. The security feature of claim 1, wherein the security feature displays a first image when viewed under visible light, and displays a second image when irradiated with the specified electromagnetic wavelength range.

24. The security feature of claim 23, wherein the second image is a coloured version of the first image, or a true RGB colour version of the first image; or a distinct image that is not correlated with the first image.

25. (canceled)

26. (canceled)

27. (canceled)

28. The security feature of claim 23, wherein the first image is a vignette image which at least partially extends into the window region of the security document; or a shadow image, or a multi-tonal image, wherein the multi tonal image includes tonal variations across different regions of the first image, wherein the tonal variations are created by the at least one opacifying layer, and/or the one or more photoluminescent ink layers.

29. (canceled)

30. (canceled)

31. (canceled)

32. (canceled)

33. The security feature of claim 1, wherein the one or more photoluminescent ink layers, and the at least one opacifying layer both display a substantially white or grey colour appearance when viewed under visible light.

34. The security feature of claim 1, wherein at least one of the photoluminescent ink layers is at least partially directly printed onto a transparent film surface of the security document.

35. (canceled)

36. The security feature of claim 1, wherein when the security feature is printed in a full window of the security document, it displays a multi-colour appearance when viewed from either side of the security document, when irradiated with the specified electromagnetic wavelength range; wherein when the security device is printed in a half window of the security document, it displays a multi-colour appearance when viewed from a first side of the security document, and a monochromatic colour appearance when viewed from a second side of the security document, when viewed in reflection viewing mode with the specified electromagnetic wavelength range; or a multi-coloured appearance when viewed from a second side of the security document, when viewed in transmission view mode with the specified electromagnetic wavelength range.

37. (canceled)

38. (canceled)

39. (canceled)

40. The security feature of claim 32, wherein the photoluminescent ink layers include titanium dioxide.

41. A security document, comprising one or more security features of claim 1.
